(19) United States
(12) Patent Application Publication
(10) Pub. No.: US 2026/0273720 A1
(43) Pub. Date: Sep. 17, 2026

(54) WASTE COLLECTION APPARATUS

(71) Applicant: Sandy Stinson, Santa Barbara, CA (US)

(72) Inventor: Sandy Stinson, Santa Barbara, CA (US)

(21) Appl. No.: 19/555,082

(22) Filed: Mar. 3, 2026

Related U.S. Application Data
(60) Provisional application No. 63/771,907, filed on Mar. 14, 2025.

(51) Int. Cl. B25G 3/00; A01K 1/01

(52) U.S. Cl. CPC B25G 3/00; A01K 1/01

(57) ABSTRACT

An apparatus for collecting and temporarily storing animal waste such as dog droppings includes a portable collection container with a pivoting cover movable between an open position and a closed position to keep contents dry. A handle attached to the container pivots the cover open and closed and is hinged to the container so that it remains in an upright vertical position until lifted upward. A removable dual-purpose waste scooper is held within the container and has a rake on one side and a shovel on the other.

### RELATED APPLICATION(S)

The present application claims priority under 35 U.S.C. 119 to U.S. Provisional Application No. 63/771,907, filed Mar. 14, 2025, the disclosure of which is incorporated by reference herein.

### FIELD OF THE INVENTION

The present application is directed to a portable container for picking up animal waste and, more particularly, to a collection container which is hygienic and simple to use.

### BACKGROUND OF THE INVENTION

Devices for collecting and disposing of animal waste such as droppings come in various shapes and forms. Some devices include an elongated, linear shaft having a handle, and sometimes an operating control, at one end and a waste engaging and collecting mechanism at the second, opposed end. By manipulating the control mechanism with the collecting mechanism disposed adjacent to the droppings, the animal waste may be collected and disposed of in a sanitary manner. Often people simply invert a small plastic or compostable bag and pick up the waste by hand, thereafter dropping the bag into a garbage can.

In the home or apartment setting, waste picked up from the yard must then be taken to the outside garbage can for disposal, which sometimes can be a significant distance. Night-time cleanup elevates the hassle.

Various waste pickup solutions are known which typically have a waste container attached to a handle and a shovel for moving waste into the container. Some of these use storage bags while others do not. One useful example is found in U.S. Pat. No. 10,711,417 to Stinson.

Despite various solutions in the field, there remains a need for a more convenient portable container for temporarily depositing waste between trips to the main garbage.

### SUMMARY OF THE INVENTION

It is an object of the present invention to provide an improved container for collecting animal waste such as dog droppings. The container allows the user to scoop and deposit the animal waste directly into a convenient portable collection container without having to touch any potentially dirty surfaces. The container has a pivoting cover movable between an open position and a closed position to keep contents dry and protect the interior from sprinklers, rain, or snow. A handle attached to the container pivots the cover open and closed and is hinged to the container so that it remains in an upright vertical position until lifted upward. A removable dual-purpose waste scooper is held within the container and has a rake on one side and a shovel on the other.

A further understanding of the nature and advantages of the invention will become apparent by reference to the remaining portions of the specification and drawings.

### BRIEF DESCRIPTION OF THE DRAWINGS

Features and advantages of the present invention will become appreciated as the same become better understood with reference to the specification, claims, and appended drawings.

FIGS. 1A and 1B are front and rear perspective views of the animal waste collection container of the present application;

FIGS. 2A and 2B are perspective views of the animal waste collection container showing the use thereof with both sides of a dual-purpose scooping tool;

FIGS. 3A and 3B are side and rear elevation views of the collection container, and FIG. 3C is a vertical sectional view taken along line 3C-3C of FIG. 3B;

FIG. 4 is an exploded perspective view of the collection container and its handle;

FIG. 5 is an exploded perspective view of the dual-purpose scooping tool;

FIG. 6 is an exploded perspective view of a shovel and rake assembly of the dual-purpose scooping tool;

FIG. 7 is a perspective view of a coupling junction of the two-purpose scooping tool;

FIG. 8 is a different exploded perspective view of the shovel and rake assembly; and

FIGS. 9A and 9B are elevational views of the assembled shovel and rake.

### DETAILED DESCRIPTION OF THE PREFERRED EMBODIMENTS

The present application is directed to an improved portable collection container for animal waste which enables a homeowner or apartment/condo management company to place convenient receptacles around an exterior of the building for temporarily collecting and storing animal waste. A handle attached to the container pivots the cover open and closed and is hinged to the container so that it remains in an upright vertical position until lifted upward. A removable dual-purpose waste scooper held within the container has a rake on one side and a shovel on the other.

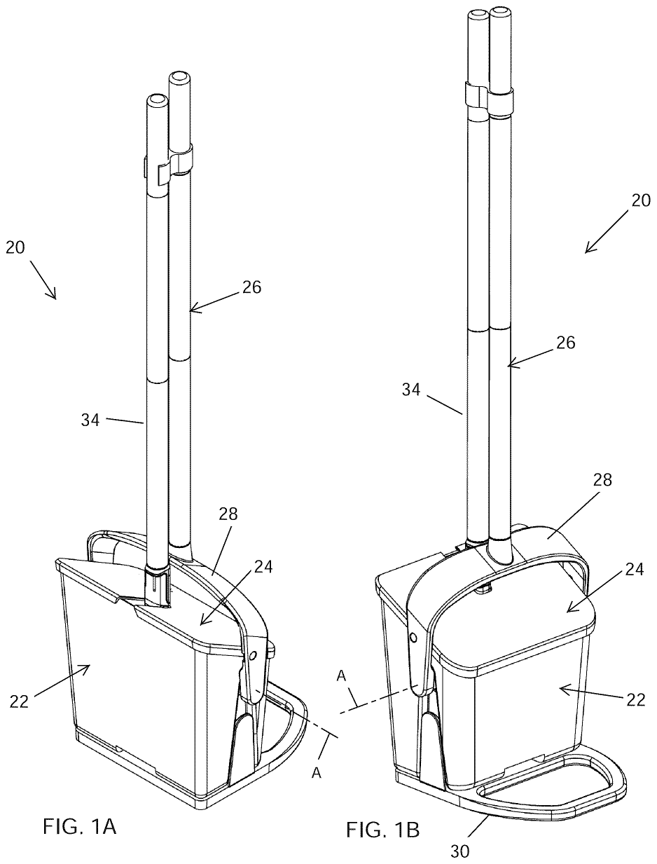

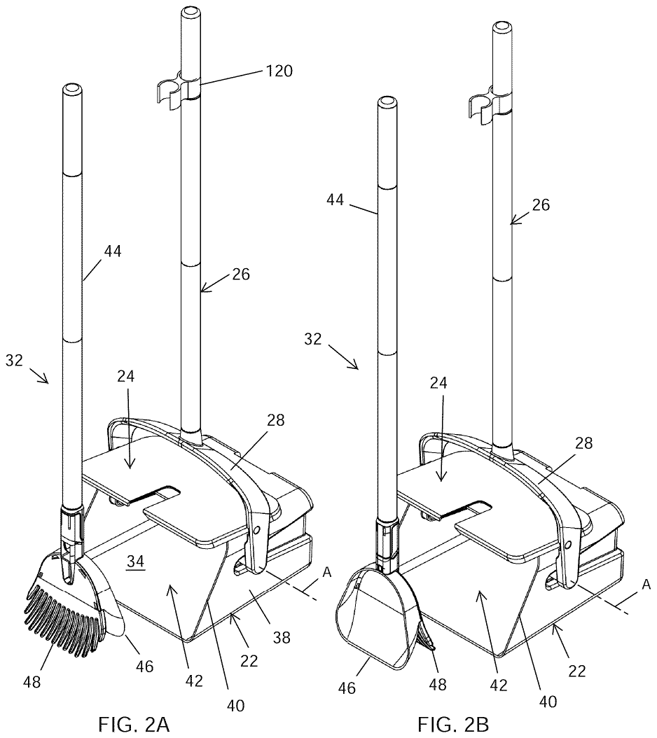

FIGS. 1A and 1B are perspective views of the animal waste collection container 20 of the present application. The container 20 comprises these main elements: a container main body 22, an upper lid 24 arranged to pivot over an open upper mouth of the main body, a control or carry handle 26 pivotally attached to the main body with a yoke 28, a lower stabilizing stand 30, and a dual-purpose scooper 32 (FIGS. 2A-2B). Preferably, the various components are molded from a suitable plastic such as polypropylene and ABS plastic, though other materials are contemplated.

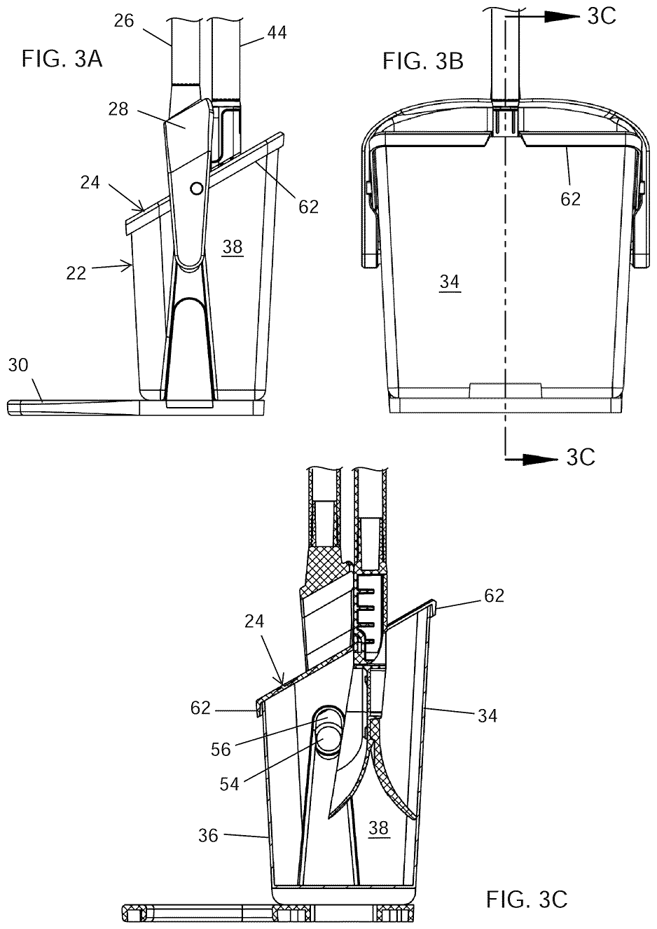

With reference also to the views of FIGS. 3A-3B, the container main body 22 has a rectilinear three-dimensional shape, with a generally-vertical front wall 34 opposite a rear wall 36, and having two substantially identical side walls 38, all extending up from a bottom wall (not seen). Each of the walls 34, 36, 38 are generally vertical or slightly tapered away from each other as they rise higher (to enable stacking for shipping and prior to assembly). As seen in FIGS. 2A-2B, an upper mouth 40 of the container main body 22 is defined by the upper edges of the front, rear and side walls 34, 36, 38. A lower end of the container main body 22 may be elevated above the ground and supported by the stabilizing stand 30.

An inner space 42 (FIGS. 2A-2B) is defined within the walls of the main body 22 and above a lower floor thereof defined by the bottom wall. In a preferred embodiment, the volume of the inner space 42 is between about 2-6 gallons. Of course, other dimensions are possible, the volume of the inner space 42 desirably being large enough to accept a number, possibly a dozen, of individual deposits of animal waste before becoming full, while at the same time having a relatively small size so as to be easily transported by hand and be placed in a convenient location without being overly obtrusive. The total weight of the empty container 20 is about 2.5 lbs, making the lifting, manipulation and transport easy for most people.

FIGS. 2A-2B illustrate the container main body 22 tilted 90° so that the front wall 34 lies parallel to the ground, and shows the dual-purpose scooper 32 in a position to rake or push material into the cavity 42. The carry handle 26 is arranged to pivot forward and rearward about a horizontal axis A extending through side walls in the main body 22, and thus facilitate tilting of the main body. The front wall 34 is taller than the rear wall 36 so that the upper mouth 40 of the main body 22 is at an angle to the horizontal (see FIG. 3A). By tilting the main body 22 forward to the ground, the edge of the upper mouth 40 at the top of the front wall 34 lies flush with the ground. This creates a dustpan shape of sorts to facilitate sweeping material into the cavity 42. The dual-purpose scooper 32 has an elongated handle 44, and a small shovel 46 and small rake 48 facing in opposite directions on the business end. Either the shovel 46 or rake 48 may be used to move matter into the cavity 42, depending on the nature of the waste.

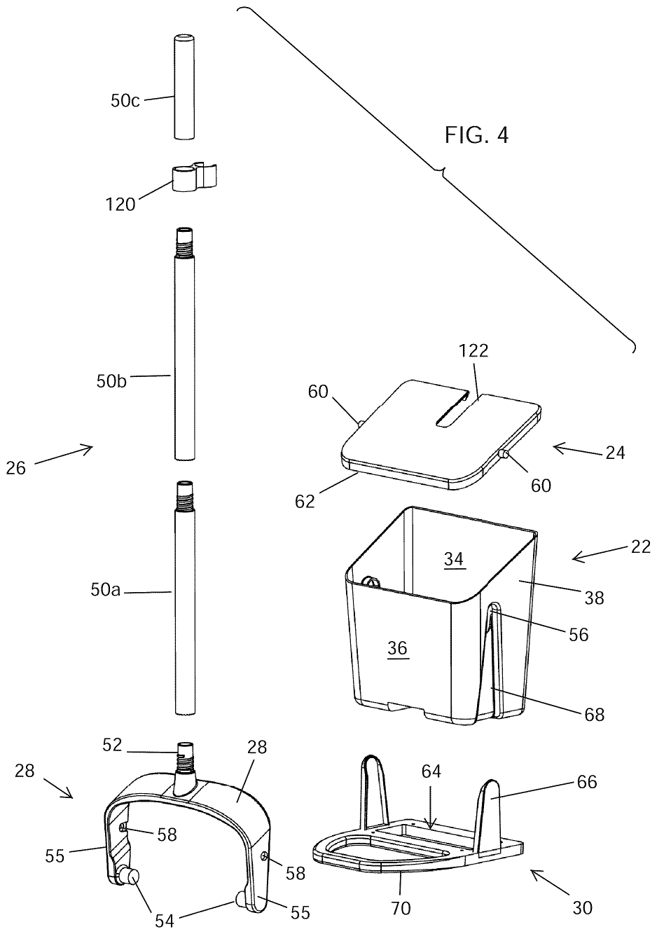

FIG. 4 is an exploded perspective view of the collection container 22 and its handle 26. The handle 26 may be separated into connectable segments 50a, 50b, 50c with mating threaded ends to facilitate shipping. The illustrated embodiment shows two longer segments and one shorter segment, but the number and length of segments can be changed depending on manufacturability and height desired by consumers. The yoke 28 also has a threaded coupler 52 to which the lowest handle segment 50a attaches. The yoke 28 includes a pair of arms 55 that extend down the sides of the main body 22 and terminate in shaft stubs 54. Shaft stubs 54 fit into relatively large pivot openings 56 in both sides of the main body 22. The pivot openings 56 are preferably elongated vertically with a circular upper portion and a narrower elongated lower portion (FIG. 3C).

The yoke 28 also engages the lid 24 so that the lid opens automatically when the handle 26 is lifted and the main body 22 is tilted horizontally forward, as in FIGS. 2A-2B. In particular, with reference back to FIG. 4, the yoke 28 has a pair of horizontally-aligned circular holes 58 through each of the arms 55. The openings 58 receive outwardly projecting pins 60 on side edges of the lid 24. As seen best in FIGS. 3A-3C, the lid 24 has a peripheral skirt 62 extending downward on all sides which closely surrounds the upper mouth 40 of the main body 22 when upright. The peripheral skirt 62 serves both to hold the lid 24 in place when the container 20 is not in use, and also acts as a barrier to rain or other moisture getting inside the cavity 42 when stored outside. Further, the skirt 62 captures the upper mouth 40 of the main body 22 and, by virtue of the engagement between the yoke arms 55 and lid 24, prevents rotation of and keeps the handle 26 in the vertical position. In this way, the handle 26 remains upright when not in use by lowering the yoke 28 so the lid 24 engages the upper mouth 40 of the main body 22.

FIGS. 2A-2B indicate how the handle 26 can be used to tilt the main body 22 horizontal to the ground, while the pin 60/hole 58 engagement causes the yoke to move the lid 24 above the main body, thus fully exposing the cavity 42. When the handle 26 is raised, the shaft stubs 54 are lifted to the upper portion of the openings 56. The elongated pivot openings 56 on the side of the main body 22 allow the yoke 28 to be lifted which carries the lid 24, separating it from the main body and allowing rotation of the lid and handle. Namely, vertical movement of the handle 26 lifts the lid 24 due to the engagement between the holes 58 and pins 60 to disengage the skirt 62 from the upper mouth 40 of the main body 22.

Still with reference to FIG. 4, the stabilizing stand 30 has a relatively wide base 64 having a front section sized to match the footprint of the bottom of the container main body 22. A pair of upstanding laterally-spaced posts 66 on the front section are slightly tapered and fit within similarly-sized and shaped channels 68 and in the sidewalls 38 of the main body 22. As seen best in FIGS. 1A and 1B, the container 20 can be supported upright by placing the main body 22 on the stand 30, with the posts 66 slotted into the channels 68 in a friction fit. The stand 30 thus allows a user to set the container 20 upright with the handle 26 vertical, obviating the need to bend over and pick the unit up. The stand 30 further includes an extended rear section 70 that provides additional stability to the container 20, preventing it from inadvertently tipping over. The rear section 70 may be approximately the same size as the front section so that the stand 30 has a footprint which is approximately twice the footprint of the main body 22.

The stand 30 is very light and may be bolted or otherwise fastened to the bottom of the container 20, or they could be coupled via a friction fit and remain as separate parts so as to leave the stand in place while using the container 20 and providing a convenient docking station. Preferably, the stand 30 is not formed as a solid, planar platform, but instead has a number of elongated ribs with openings therebetween to reduce its weight and forming handles to facilitate grasping. The stand 30 can thus be used as a handle when it is bolted or otherwise coupled to the bottom of the container 20. This makes grasping and tipping the contents into a collection or trash bin or a toilet easy (flushing dog poop is a sound way to dispose of it as it may contain toxins).

Attention is now drawn to the dual-purpose scooping tool 32, which is shown in greater detail in FIGS. 5-9. FIG. 5 shows the tool 32 exploded. The handle 44 may be formed of a series of connectable tubular segments 45a, 45b, 45c which have mating threaded ends. A lower segment 45a connects to a coupling member 72 shown enlarged in FIG. 7. The coupling member 72 as an upper threaded boss 74 to mate with the lower handle segment 45a, and a lower rail structure 76 configured to mate with a coupler 78 provided at the top of the shovel 46. The rail structure 76 inserts within a channel-like cavity 80 in the coupler 78, and a pair of outward flanges 82 in conjunction with a snap-fit engagement (not shown) ensure a solid connection. Furthermore, the shovel 46 and rake 48 are also detachable, as will be shown. In this way, the entire dual-purpose scooping tool 32 can be disassembled for easier shipping. Moreover, separately forming the shovel 46 and rake 48 may be necessary for manufacturing, and at least lowers fabrication costs.

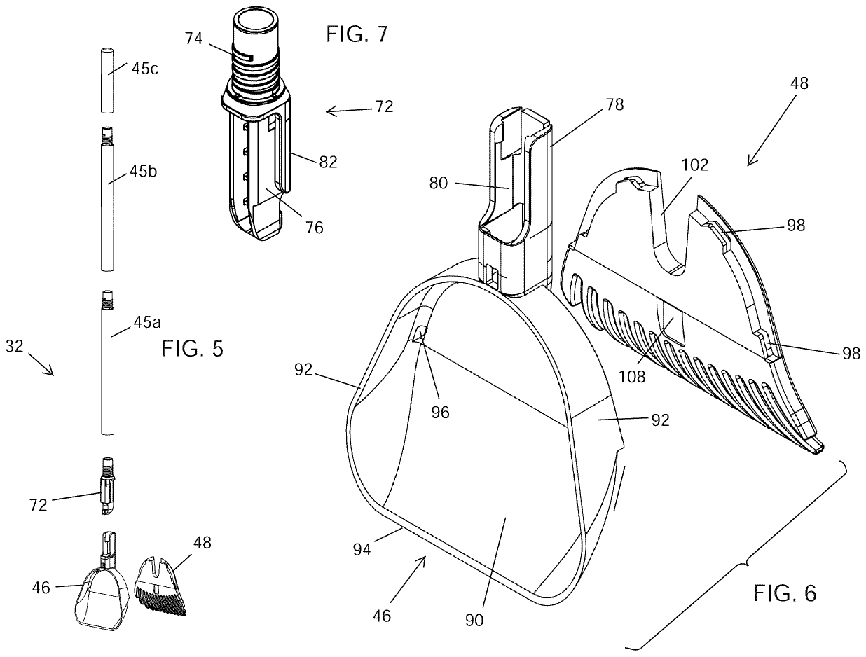

FIG. 6 is an exploded perspective view of the shovel 46 and rake 48 assembly of the dual-purpose scooping tool 32. The shovel 46 has a wide, slightly curved midsection 90 bordered by sidewalls 92 on three sides. The sidewalls 92 taper down at a front lip edge 94 which is preferably linear for wider coverage. As seen also in FIG. 9A, the shovel 46 features a plurality of connecting holes 96 distributed around the intersection of the midsection 90 and sidewalls 92. The connecting holes 96 receive connecting tabs 98 provided on the rake 48.

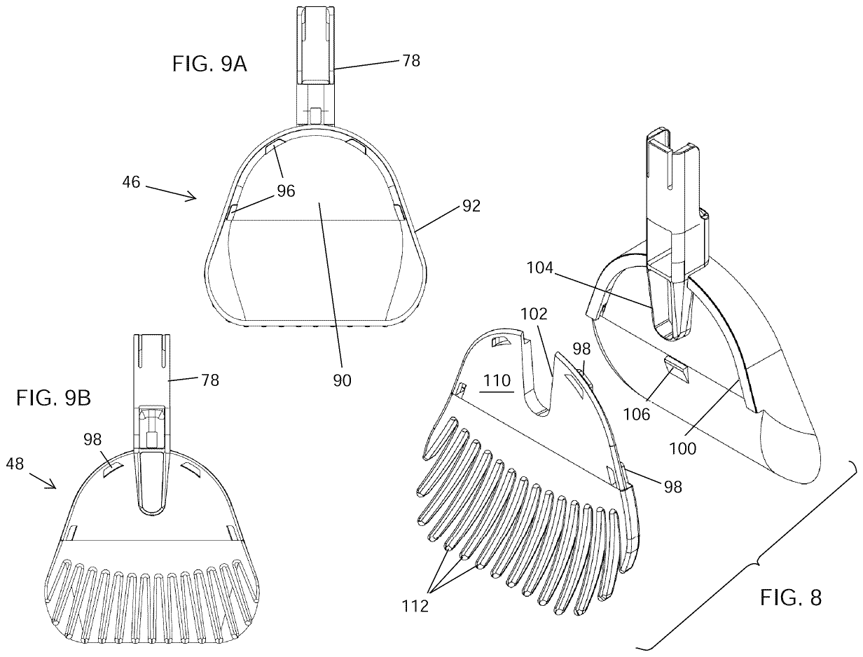

As seen in FIGS. 6 and 8, the rake 48 has a stepped rear face which fits within a generally semi-circular cavity formed by an outer rail 100 on the rear of the shovel 46. The connecting tabs 98 are shaped to snap into the connecting holes 96 to secure the shovel 46 and rake 48 together in one unit. Additional stability to this connection is provided by a slightly tapered upwardly-opening central slot 102 on the rake 48, which receives a similarly-shaped rib 104 on the rear of the shovel 46. A small rectangular snap member 106 on the rear of the shovel 46 snaps into a rectangular depression 108 (FIG. 6) on the rear face of the rake 48. The ability to separate the shovel 46 and rake 48 further facilitates a more compact shipping assembly. The rake 48 has a solid palm region 110 (FIG. 8) which transitions into a plurality of separated fingers or tines 112 at its lower end. Both the rake 48 and the shovel 46 curve slightly apart at their lower edges when joined together, as seen best in FIG. 3C.

A further advantageous feature of the animal waste collection container 20 is the ability to store the combined shovel 46 and rake 48 subassembly within the cavity 42 of the main body 22. This is seen in FIGS. 1A and 1B, and also in the cross-section of FIG. 3C. The handle 26 of the container has a clip connector 120 that can be secured on the upper segment 45c. The clip connector 120 has a C-shaped clip projecting therefrom into which the tubular handle 26 of the dual-purpose scooping tool 32 can be snapped. The two handles 26, 40 thus are stored adjacent and parallel to each other in a unitary fashion, with the subassembly of the shovel 46 and rake 48 positioned within the inner cavity 42 by virtue of an elongated slot 122 formed in the lid 24 (see, e.g., FIG. 4). This arrangement conceals the shovel 46 and rake 48, and also positions them for convenient usage. Optionally, the coupling member 72 or coupler 78 include a flange or ledge of some sort which is larger than and thus interferes with the elongated slot 122 such that the subassembly of the shovel 46 and rake 48 is suspended above the floor of the main body 22, as seen in FIG. 3C. This keeps the shovel 46 and rake 48 above any waste within the inner cavity 42 of the container 20. The lid 24 closes over the scoop/rake combination 46, 48, which helps reduce mess and toxins (dog poop may have toxins in it).

### Conclusion

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A portable animal waste collection container assembly, comprising:
a container main body having front, rear and side walls extending upward from a bottom wall and terminating in an upper mouth opening to an inner cavity;
a carry handle having a yoke with a pair of arms arranged to flank the side walls of the main body and pivot forward and rearward about a horizontal axis extending through the side walls;
an upper lid sized to rest on and cover the upper mouth and coupled to the yoke so that lifting and pivoting movement of the carry handle and yoke with respect to the main body lifts the upper lid and carries the lid out of contact with the upper mouth to expose the inner cavity; and
a dual-purpose waste scooper partly held within the inner cavity having a distal end with a subassembly of an oppositely-facing rake and shovel.

2. The assembly of claim 1, wherein the front wall is taller than the rear wall so that the upper mouth lies in an angled plane when the main body stands upright.

3. The assembly of claim 1, wherein the upper lid defines a downwardly-extending peripheral skirt that closely surrounds and extends downward below the upper mouth.

4. The assembly of claim 3, wherein the arms of the carry handle yoke has inwardly-directed shaft stubs that fit into pivot openings defined in the side walls in the main body, and the pivot openings are vertically elongated to permit the shaft stubs to be lifted up within the pivot openings and lift the peripheral skirt above the upper mouth so that the upper lid can be moved out of contact with the upper mouth to expose the inner cavity upon pivoting movement of the carry handle.

5. The assembly of claim 1, wherein the rake and shovel are separately molded plastic components that snap together.

6. The assembly of claim 5, wherein the subassembly of the rake and shovel has an upper coupler to which a coupling member attaches in a snap-fit assembly, the coupling member having an upper threaded boss, and the waste scooper has a scooper handle including a tubular segment with a lower threaded end that mates with the upper threaded boss.

7. The assembly of claim 6, wherein the scooper handle includes a series of connected tubular segments.

8. The assembly of claim 1, wherein the carry handle has a series of connected tubular segments a lower one of which has a lower threaded end that mates with an upper threaded coupler on the yoke.

9. The assembly of claim 1, further including a lower stabilizing stand having a front section sized to match a footprint of the bottom wall of the main body, the stand including a rear section that extends rearward from the container main body and provides stability thereto.

10. The assembly of claim 9, wherein the stand has a pair of upstanding tapered lateral posts on either side of the front section that mate with similarly-sized and shaped channels formed in the side walls of the main body to provide a stable friction fit therebetween.

11. A portable animal waste collection container assembly, comprising:
a container main body having front, rear and side walls extending upward from a bottom wall and terminating in an upper mouth opening to an inner cavity;
a carry handle having a yoke arranged to pivot forward and rearward about a horizontal axis extending through the side walls in the main body;
an upper lid sized to rest on and cover the upper mouth and coupled to the yoke so that pivoting movement of the carry handle and yoke with respect to the main body carries the lid out of contact with the upper mouth to expose the inner cavity;
a waste scooper with a shovel on a distal end partly held within the inner cavity and a scooper handle projecting up out of the inner cavity parallel to the carry handle; and
a lower stabilizing stand having a front section sized to match a footprint of the bottom wall of the main body, the stand including a rear section that extends rearward from the container main body and provides stability thereto.

12. The assembly of claim 11, wherein the front wall is taller than the rear wall so that the upper mouth lies in an angled plane when the main body stands upright.

13. The assembly of claim 11, wherein the upper lid defines a downwardly-extending peripheral skirt that closely surrounds and extends downward below the upper mouth.

14. The assembly of claim 13, wherein the carry handle yoke has a pair of arms arranged to flank the side walls of the main body each having inwardly-directed shaft stubs that fit into pivot openings defined in the side walls in the main body, and the pivot openings are vertically elongated to permit the shaft stubs to be lifted up within the pivot openings and lift the peripheral skirt above the upper mouth so that the upper lid can be moved out of contact with the upper mouth to expose the inner cavity upon pivoting movement of the carry handle.

15. The assembly of claim 11, wherein the waste scooper includes a subassembly of an oppositely-facing rake and the shovel.

16. The assembly of claim 15, wherein the rake and shovel are separately molded plastic components that snap together, and further including a clip connector secured on the carry handle having a C-shaped clip projecting therefrom that receives and holds the scooper handle.

17. The assembly of claim 11, wherein the scooper handle includes a series of connected tubular segments one of which has a lower threaded end that mates with an upper coupler of the shovel.

18. The assembly of claim 11, wherein the carry handle has a series of connected tubular segments a lower one of which has a lower threaded end that mates with an upper threaded coupler on the yoke.

19. The assembly of claim 11, wherein the stand has a pair of upstanding tapered lateral posts on either side of the front section that mate with similarly-sized and shaped channels formed in the side walls of the main body to provide a stable friction fit therebetween.

20. The assembly of claim 11, wherein the stand is formed by elongated ribs with openings therebetween to reduce weight and form handles to facilitate grasping.
